(19) United States
(12) Patent Application Publication
(10) Pub. No.: US 2004/0117533 A1
(43) Pub. Date: Jun. 17, 2004

(54) Simplified user interface for UPS monitoring

(76) Inventors: Ray Fallon, Galway (IE); Noel Fegan, Galway (IE); Jacqueline Hayes, Galway (IE); Eddie Grogan, Mayo (IE); David Mathieson, Galway (IE)

Correspondence Address: MINTZ, LEVIN, COHN, FERRIS,, GLOVSKY and POPEO, P.C., One Financial Center, Boston, MA, 02111, US

(21) Appl. No.: 10/318,996

(22) Filed: Dec. 13, 2002

(51) Int. Cl. G06F 13/24

(52) U.S. Cl. 710/260

(57) ABSTRACT

A simplified user interface for UPS monitoring provides significant information regarding UPS events in an understandable format for the novice user. Information relating to operation of the UPS is stored by a monitoring system. The stored information is analyzed to determine the number of occurrences of certain types of events. The user interface displays a last occurrence of certain predetermined events and a table of numbers of occurrences of certain other predetermined events.

### BACKGROUND OF THE INVENTION

1. Field of the Invention

The present invention relates to computer systems utilizing an uninterruptible power supply (UPS) for emergency power. More particularly, it relates to a personal computer system providing information to a user on performance and operation of a connected UPS.

2. Discussion of Related Art

An uninterruptible power supply (UPS) is used in conjunction with electronic equipment to provide backup power in the event of loss of or problems with a primary power source, typically utility power. While a UPS can be used to provide power to any type of electronic equipment, typically they are used in conjunction with computer systems. The UPS receives power from the utility by being plugged into an outlet or hardwired into the power system for the building. The UPS provides output power to one or more computers and peripheral equipment through power outlets.

Typically, the UPS includes a battery as a source of backup power and an inverter for converting the battery power into regular 110 volt (or other applicable voltage), AC power for use by the computer equipment. The UPS monitors the input power from the utility to determine its continuing supply and condition. In the event of power failure, the UPS switches to the battery backup power source. The backup power source is used until utility power returns or the battery is drained. If the power failure last a long time so that the battery becomes drained, the UPS shuts off to prevent damage to the battery. In the event of a power failure, the computer equipment can continue to be used until the UPS shuts off. The time period until shut off depends upon the condition of the battery, the charge on the battery, and the amount of power being utilized by the computer equipment. The UPS may also be used to condition the power to correct for over or under voltage conditions.

Originally, a UPS had a visual or audio signal to indicate that a power failure had occurred. The computer user would have to monitor the system to determine when to shut down the computer so as to prevent loss of data prior to shut down of the UPS. More sophisticated UPSs have been developed which include microprocessors for monitoring operation of the UPS to determine the current state, changes in state, and to perform diagnostic self-tests. The UPS also includes a communication link to the computer system to provide information relating to its states. UPS control and monitoring software operating on the computer system operates to store, analyze, and display information for a user regarding the condition, status, and operation of the UPS. The UPS control software may also function to shut down the computer system prior to a shut down of the UPS, when on backup power.

Typically, the monitoring software provides various notifications to the user, such as with pop-up windows, relating to specific events relating to operation of the UPS. The events may also be collected with time information in a log for review by the user. Additionally, various graphical displays may be provided representing current status of the UPS or status over a defined time period. However, existing monitoring software is not particularly useful for novice computer users. A log of data identifying chronological occurrences of UPS events has little meaning to the inexperienced individual. Furthermore, a simple historical graph of events can be confusing without extensive knowledge relating to analysis of the graph. Therefore, a need exists for a simplified system which stores and provides information about UPS usage and status to the user in an understandable and useful manner.

### SUMMARY OF THE INVENTION

The deficiencies of the prior art are substantially overcome by the present invention which includes UPS monitoring software having a simplified user interface for providing UPS performance and status information. According to an aspect of the invention, the monitoring software logs UPS events and displays the information in a meaningful manner for novice computer users. The display includes the last occurrence of certain UPS events. It also includes the number of occurrences of UPS events. The information may be organized with repsect to different types of UPS events. According to another aspect of the invention, the monitoring system provides graphical information regarding the current status of UPS operation. According to another aspect of the invention, the monitoring system provides a performance summary including the most recent times the UPS has taken action. According to another aspect of the invention, the monitoring system provides a summary of actions taken by the UPS during a predetermined time interval.

### BRIEF DESCRIPTION OF THE DRAWINGS

FIG. 1 illustrates a user interface for a monitoring system according to an embodiment of the present invention.

### DETAILED DESCRIPTION

The present invention relates to a novel user interface for a UPS monitoring system. The monitoring system operates as computer program on the computer system communicating with a UPS. Many features of the monitoring system are identical or similar to those for existing monitoring systems. In particular, the monitoring system of the present invention requires a UPS to provide power to the computer system utilizing the monitoring system. The UPS can be of any known or later developed type which can monitor its own status and which communicates information with the attached computer system. Any known system for communicating information between the UPS and the computer can be used in the monitoring system of the present invention. As in known systems, the present invention continuously monitors operation of the UPS and creates a log of UPS events. UPS events include the status or changes in status of the UPS. For example, UPS events may be occurrences of power failures, over voltage, under voltage or excessive electrical noise conditions. UPS events also may include actions performed by the UPS, such as switching to battery power, switching to utility power, performing a self-test, or performing a managed shut down of the computer and UPS. The system also allows the user to change characteristics of the operation of the UPS. The changed characteristics are communicated by the monitoring system to the UPS in known manners.

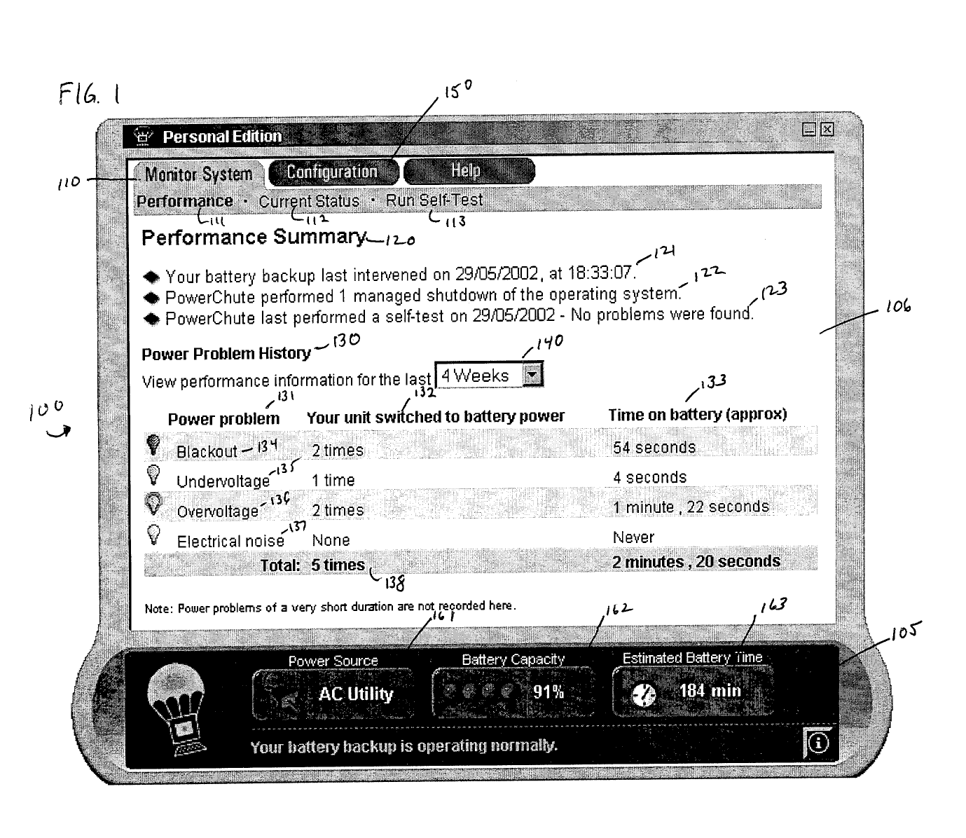

The present invention is characterized by the novel user interface for providing useful information about UPS events to the user. An embodiment of the user interface 100 according to the present invention is illustrated in FIG. 1. The user interface 100 is created as part of the software of the monitoring system. The user interface 100 may be constantly available on the display of the user or may be displayed when selected by the user.

The user interface 100 includes a UPS status section 105 and a UPS monitor section 106. The UPS status section 105 provides information, preferably in a graphical format, of key features of the current status of the UPS. For example, as illustrated in FIG. 1, the current status section 105 may include displays indicating the power source 161, battery capacity 162, and remaining battery time 163. The power source display 161 identifies whether the UPS is receiving utility power or using the battery. The battery capacity display 163 indicates the percentage of total battery power remaining. It may do so with a numerical value and/or a gauge display, as shown. The remaining battery time display 163 provides information from the UPS regarding the estimated time the computer system could operate on battery at the present usage rate and battery capacity. Of course, the present invention is not limited to the specific information represented in the UPS status section in FIG. 1. More, less, or different information may be included depending upon the needs of the users of the system. Additionally, the system may be configurable by the user through selection of the desired information to be included in the UPS status section 105.

The UPS monitor section 106 of the user interface 100 provides information, in a summary format, regarding historical operation of the UPS and allows control of the UPS monitoring functions. The UPS monitor section 106 is organized with various upper level and lower level displays. FIG. 1 illustrates the Monitor System upper level display 110 and the Performance lower level display 111 according to an embodiment of the present invention. Upper level displays are selected by tabs 110, 150 at the top of the user interface display. They relate to general types of information to be displayed and/or actions selectable by the user. As illustrated in FIG. 1, in an embodiment of the invention, upper level displays include the Monitor System 110, Configuration 150, and Help. Of course, the upper level displays could be organized differently and include different information. Lower level displays are used to select specific information for display or action by the user. As illustrated in FIG. 1, the lower level displays are selected under the tabs and include, for the Monitor System upper level display 110, Performance 111, Current Status 112, and Run Self-Test 113. Of course, other or additional information could be included under the Monitor System upper level display 110.

FIG. 1 further illustrates the novel performance display 111 of the present invention which creates a simplified representation of historical information relating to UPS events. According to an embodiment of the present invention, the performance display 111 includes two sections, summary 120 and history 130. The performance summary section 120 lists the most recent occurrence of certain types of UPS events. According to an embodiment of the invention, as illustrated in FIG. 1, the performance summary section 120 lists the last occurrence of battery usage 121, managed shutdown 122, and self-test 123. Of course, other or additional events could be included in the summary. Similarly, the summary could list more than one occurrence of a specific type of event. The performance summary section 120 provides a simple display of the most significant information relating to UPS usage and is readily understood by the novice user.

The history section 130 provides a useful summary of past occurrences of certain types of UPS events, in a tabular format. The typical log of UPS events recorded and displayed by monitoring systems is not very useful for inexperienced users. The monitoring system of the present invention includes an event log, which could be displayed to the user. However, the monitoring system analyzes the event log to provide summary information in the history section 130. The history section 130 of the present invention provides a summary of events which can be readily understood by novice users. For example, as illustrated in FIG. 1, the history section 130 includes a table identifying different types of power problems 131, the number of occurrences 132, and the time for which the battery was utilized due to the power problem. Types of power problems may include blackouts 134, undervoltages 135, overvoltages 136, and electrical noise 137. The history section 130 also includes a total 138 of the power conditions and the time on battery. An individual can readily determine the performance of the UPS and its usefulness in the history section 130.

According to an embodiment of the present invention, the time period covered by the history section 130 is selectable by the user. A drop down menu 140 can be used to select different time periods, in days, weeks, months or years, to be included in the history section 130. According to an embodiment of the invention, selectable time periods are one, four, twelve and twenty-four weeks. Depending upon the reliability of the utility power source, the UPS may be utilized more or less. Thus, the user can select an appropriate time period for the history section which provides useful information. The event log in the monitoring system may store all events until deleted by the user. Alternatively, the event log may be automatically purged of information relating to events longer than the maximum selectable time period for display.

Other upper level and lower level displays in the user interface 100 are used to display information or control operation of the UPS and monitoring system similar to those features in known monitoring systems. For example, the Monitor System upper level display 110 includes lower level displays for current status 112 and Run Self-Test 113. The Current Status display 112 provides information regarding the status of the UPS. The status information may include information in addition to that in the UPS status section 105 of the user interface 100. The information which can be displayed depends upon the information available from the UPS. The Run Self-Test display 113 is provided for the user to control operation of self-tests by the UPS. The user may manually initiate a self test or may select a time period for automatic operation of the self test.

The Configuration upper level display 150 is used to set up the UPS. It includes lower level displays as appropriate for selecting parameters appropriate for the particular UPS being use. Parameters may include time periods for shut down notification, voltage levels for determination of over or under voltage conditions, and other known selectable parameters of UPS operation.

According to another embodiment of the present invention, the monitoring system utilizes information balloons in a Windows operating system to provide notifications to the user. A monitoring system regularly provides notifications to a user upon occurrence of certain events, such as changes between utility power and battery power conditions, shut down times, etc. The notifications can be displayed as pop-up windows. Alternatively, current Windows operating systems allow notification balloons as small windows near the taskbar of the system. The user interface utilizes the notification balloons for providing system notifications.

Having described as least one embodiment of the invention, adaptations, modifications, variations and improvements will be readily understandable to those of skill in the art. These adaptations, modification and variations are part of the present invention which is only limited by the attached claims.

1. A monitoring system for monitoring operation of an uninterruptible power supply (UPS), wherein the UPS is connected to and provides status information to the monitoring system, the monitoring system comprising:
storing means for storing information relating to the occurrence of events on the UPS;
analyzing means for analyzing the stored information to determine a number of occurrences of events corresponding to at least one predetermined event type; and
display means for displaying a table of event types and a corresponding number of occurrences for the event type.

2. The monitoring system according to claim 1, further comprising:
display means for displaying stored information relating to a last occurrence of at least one predetermined event type.

3. The monitoring system according to claim 2, wherein the at least one predetermined event types includes at least one of: a battery usage, a managed shutdown, and a self-test.

3. The monitoring system according to claim 1, wherein the at least one predetermined event types include at least one of: blackout, undervoltage, overvoltage and electrical noise.

4. The monitoring system according to claim 1, wherein the analyzing means determines a number of occurrence during a predetermined time period.

5. The monitoring system according to claim 4, means for receiving a user input to select the predetermined time period.

6. A user interface for a system for monitoring an uninterruptible power supply (UPS), the system storing information relating to occurrences of events on the UPS, the user interface comprising:
a first display for displaying at least one occurrence for each of at least one predetermined event types;
means for analyzing the stored information to determine a number of occurrences for at least one predetermined event type; and
a second display for displaying the at least one predetermined event type and a corresponding number of occurrences.

7. The user interface according to claim 6, wherein the analyzing means determined a number of occurrences for a predetermined time period.

8. The user interface according to claim 7, further comprising means for receiving the predetermined time period from a user.

9. A method for displaying information relating to occurrences of events on an uninterruptible power supply, the method comprising the steps of:
determining a number of occurrences of events for each of a plurality of event types; and
displaying the plurality of event types and a corresponding number of occurrences.

10. The method for displaying information according to claim 9, further comprising the steps of:
determining a last occurrence of an event corresponding to a second plurality of event types; and
displaying information regarding the last occurrence of each of the second plurality of event types.

11. The method for displaying information according to claim 9, wherein the determining step includes determining a number of occurrences of events for a predetermined period of time.

12. The method for displaying information according to claim 11, further comprising the step of selecting the predetermined period of time.
